(19) United States
(12) Patent Application Publication
(10) Pub. No.: US 2021/0127681 A1
(43) Pub. Date: May 6, 2021

(54) USE OF HERBICIDAL COMPOSITIONS BASED ON L-GLUFOSINATE IN TOLERANT FIELD CROPS

(71) Applicant: BASF SE, Ludwigshafen am Rhein (DE)

(72) Inventors: Lothar LORENTZ, Leverkusen (DE); Roland DECKWER, Leverkusen (DE); Arlene COTIE, Whippany, NJ (US); Ralph BAGWELL, Chapel Hill, NC (US)

(21) Appl. No.: 16/633,482

(22) PCT Filed: Jun. 20, 2018
(86) PCT No.: PCT/EP2018/066403

§ 371 Date: Jan. 23, 2020

Related U.S. Application Data
(60) Provisional application No. 62/537,511, filed on Jul. 27, 2017.

(51) Int. Cl. A01N 57/20

(52) U.S. Cl. CPC A01N 57/20

(57) ABSTRACT

The present invention primarily relates to the use of compositions comprising L-glufosinate and/or salts thereof in a glufosinate tolerant field crop in foliar application, wherein the compositions contain less than 5 mol.-% of D-glufosinate and/or salts thereof, based on the total amount of L-glufosinate and salts thereof, under certain environmental conditions to achieve an increase in the control of harmful plants and/or a reduction of phytotoxicity in the tolerant field crop. The present invention also relates to according methods of treating a tolerant field crop using the mentioned compositions.

Use of Herbicidal Compositions Based on L-Glufosinate in Tolerant Field Crops

The present invention primarily relates to the use of compositions comprising L-glufosinate and/or salts thereof in a glufosinate tolerant field crop in foliar application, wherein the compositions contain less than 5 mol.-% of D-glufosinate and/or salts thereof, based on the total amount of L-glufosinate and salts thereof, under certain environmental conditions to achieve an increase in the control of harmful plants and/or a reduction of phytotoxicity in the tolerant field crop. The present invention also relates to according methods of treating a tolerant field crop using the mentioned compositions.

U.S. Pat. No. 4,168,963 describes phosphorus-containing compounds with herbicidal activity, of which phosphinothricin ((D,L)-2-amino-4-[hydroxy(methyl)phosphinyl]butanoic acid, common name: glufosinate) is commercially available as monoammonium salt and is used as foliar herbicide.

Glufosinate can be employed for sucker control and the control of weeds in fruit growing and viticulture, in plantation crops, in vegetable growing prior to sowing or transplanting, prior to direct sowing of maize , soybeans, cotton, canola, sugarbeets, sweet corn, cereals, rice and also on uncultivated land, such as roadsides and railroad tracks.

U.S. Pat. No. 4,265,654 teaches that glufosinate and its metal salts can be used as perennial weeds and brush controlling agents, and that the L-isomer is twice as effective than the racemic acid.

WO 2016/180755 A1 discloses herbicide combinations comprising (i) L-glufosinate and/or salts thereof and (ii) indaziflam for use as plant growth regulators and for controlling harmful plants or undesired plant growth.

From U.S. Pat. No. 5,646,024 a process for the protection of genetically modified crops is known, i.e. the selective use of glufosinate for controlling weeds in crops of useful plants, which have been made resistant by gene technology.

U.S. Pat. Nos. 6,677,276 B1, 6,723,681 B1, 8,772,199 B2, 7,105,470 B1, 8,338,332 B1 and 8,614,166 B2 disclose methods of controlling harmful plants in glufosinate tolerant oilseed rape, cereal, maize, soybean or cotton, sugarbeets, rice crops, by applying certain combinations of glufosinate with other herbicides.

Glufosinate tolerant crop plants typically have a pat or bar gene that codes for phosphinothricin acetyltransferase (PAT) enzyme production (pat gene and bar gene are very similar). The PAT enzyme in tolerant crop plants detoxifies the herbicidally active L-glufosinate compound (an irreversible inhibitor of the glutamine synthetase activity) by acetylation into the herbicidally inactive corresponding N-acetyl-L-glufosinate compound, such that the crop plant is tolerant, i.e. exhibits resistance, to L-glufosinate.

Planta 2016, 243, 925-233 reports that the resistance to glufosinate is proportional to phosphinothricin acetyltransferase expression and activity in LibertyLink® and WideStrike® cotton.

In their application, herbicidal crop protection agents (herbicides) like racemic glufosinate and/or agronomically acceptable salts thereof for controlling harmful plants or unwanted vegetation, under certain environmental conditions still have some disadvantages, for example (a) that the selectivity of herbicides in tolerant field crops is lower than desired, thereby causing unwanted damage (i.e. phytotoxicity) and/or unwanted reduced harvest yields of said field crops, (b) that the herbicidal activity against harmful plants or unwanted vegetation is not high enough, (c) that the amount (dose rate) of herbicide needed to achieve sufficient control of harmful plants or unwanted vegetation is too high.

Overall, the herbicidal activity profile under certain environmental conditions of racemic glufosinate and/or agronomically acceptable salts thereof, i.e. one or more of the above aspects (a), (b) and/or (c), still allow some improvement.

Surprisingly, it has now been found that certain compositions as defined and used in the context of the present invention exhibit the desired herbicidal activity profile and are able to control harmful plants or unwanted vegetation in a more effective and more efficient manner, and at the same time cause less unwanted damage (i.e. less phytotoxicity) and/or unwanted reduced harvest yields of glufosinate tolerant field crops.

The present invention primarily relates to the use of a composition comprising a herbicidally effective amount of L-glufosinate and/or agronomically acceptable salts thereof in a glufosinate tolerant field crop, wherein the composition contains less than 5 mol.-% of D-glufosinate and/or agronomically acceptable salts thereof, based on the total amount of L-glufosinate and salts thereof, to achieve

(i) an increase in the control of harmful plants, in comparison to twice the molar amount of racemic glufosinate and/or agronomically acceptable salts thereof,

and/or

(ii) a reduction of phytotoxicity, in particular of chlorosis and/or stunting, caused to the glufosinate tolerant field crop,in comparison to the same molar amount of racemic glufosinate and/or agronomically acceptable salts thereof,

wherein the composition is used in foliar application at an air temperature of 18° C. or above, preferably of 21° C. or above, and more preferably of 24° C. or above, in each case when measured 2 m above the ground.

It has been found that the herbicidal activity profile of racemic glufosinate and/or agronomically acceptable salts thereof can be improved when a composition as defined in the context of the present invention is used under the environmental conditions defined herein, in particular the disadvantages of one, two or all of aspects (a), (b) and/or (c) mentioned above.

The application of compositions as defined and used in the context of the present invention allows causing less injury, i e minimizing injury, in glufosinate tolerant field crop in comparison to racemic glufosinate and/or agronomically acceptable salts thereof. Thus, the compositions as defined and used in the context ofthe present invention result in less unwanted damage (i.e. phytotoxicity) and/or unwanted reduced harvest yields of glufosinate tolerant field crops under the environmental conditions defined herein, in particular less chlorosis and/or stunting, in comparison to racemic glufosinate and/or agronomically acceptable salts thereof (aspect (a) mentioned above).

Chlorosis or also called flush or flash after a glufosinate treatement becomes visible within a few (up to 5) days after glufosinate treatment as discoloration of the intercostal field on the treated leaves of glufosinate tolerant crops like canola, corn, soybean and cotton. The color of the treated intercostal fields can vary from yellow-greenish to yellowish sometimes even turning into a slight bronzening colour and appear in more severe cases across the whole leaf. Leaves which newly develop after the glufosinate treatment do not show this effect.

Stunting in a crop plant after glufosinate treatment becomes visible as reduced, slowed down and/or more compact growth of the crop plant compared to an untreated plant grown under the same conditions. This effect is also visible several weeks after the herbicide treatment as overall smaller plants compared to untreated plants grown under the same conditions.

The compositions as defined and used in the context of the present invention also show remarkably higher/stronger herbicidal activity than racemic glufosinate and/or agronomically acceptable salts thereof (see above mentioned aspect (b)), in particular under the environmental conditions defined herein

The compositions as defined and used in the context of the present invention also allow the application rate (dose rate) required to achieve sufficient control of harmful plants or unwanted vegetation to be reduced in comparison to racemic glufosinate and/or agronomically acceptable salts thereof (aspect (c) mentioned above), in particular under the environmental conditions defined herein.

If the compositions as defined and used in the context of the present invention are applied to the green parts (foliar application) of the harmful plants or undesired plants, growth likewise stops drastically a very short time after the treatment; typically, they die completely after a certain time, so that in this manner competition by the weeds, which is harmful to the field crops, is eliminated in a sustained manner.

The effects observed when using the compositions as defined and used in the context of the present invention allow a more potent herbicidal action (in particular a higher/stronger initial herbicidal activity), an extended herbicidal activity period and/or a reduced number of required individual applications and —as a result—more advantageous weed control systems both from an economical and ecological point of view.

Overall, when the compositions as defined and used in the context of the present invention are employed application rates may be reduced, the herbicidal action may take place more rapidly, the harmful plants may be controlled better while using only one, or few, applications.

As used herein, “glufosinate tolerant” plants are plants which are tolerant to the application of glufosinate herbicides.

In one embodiment, glufosinate tolerant plants are plants which comprise and express a gene comprising the following operably linked DNA fragments:
a) a plant expressible promoter;
b) a DNA region encoding a protein with phosphinotricin acetyltransferase activity; and
c) optionally, a transcription termination and polyadenylation region functional in plant cells.

The gene may further comprise additional elements, such as a 5′ untranslated region or leader sequence.

An enzymatic test for assaying phosphinotricin acetyltransferase activity is described e.g. in WO 87/05629 or on page 2517 in De Block et al., The EMBO Journal 1987, Vol. 6 no. 9, 2513-2518 (herein incorporated by reference).

In the context of the present invention, reference is made to the following sequences:
SEQ ID No. 1: amino acid sequence of the BAR protein from Streptomyces hygroscopicus
SEQ ID No. 2: amino acid sequence of the BAR protein variant described in WO87/05629
SEQ ID No. 3: amino acid sequence of the PAT protein from Streptomyces viridichromogenes
SEQ ID No. 4: nucleotide sequence of the bar coding region from S. hygroscopicus (with ATG start codon)
SEQ ID No. 5: nucleotide sequence of the bar coding region variant described in WO87/05629
SEQ ID No. 6: nucleotide sequence of the pat coding region from S. virdochromogenes (with ATG start codon)
SEQ ID No. 7: nucleotide sequence of the synthetic pat coding region described in U.S. Pat. No. 5,276,268

SEQ ID No. 1: BAR protein
MSPERRPADIRRATEADMPAVCTIVNHYIETSTVNFRTEPQEPQEWTDDLVRLRERYPWL
VAEVDGEVAGIAYAGPWKARNAYDWTAESTVYVSPRHQRTGLGSTLYTHLLKSLEAQGFK
SVVAVIGLPNDPSVRMHEALGYAPRGMLRAAGFKHGNWHDVGFWQLDFSLPVPPRPVLPV
TEI
SEQ ID No. 2: BAR* protein
MDPERRPADIRRATEADMPAVCTIVNHYIETSTVNFRTEPQEPQEWTDDLVRLRERYPWL
VAEVDGEVAGIAYAGPWKARNAYDWTAESTVYVSPRHQRTGLGSTLYTHLLKSLEAQGFK
SVVAVIGLPNDPSVRMHEALGYAPRGMLRAAGFKHGNWHDVGFWQLDFSLPVPPRPVLPV
TEI
SEQ ID No. 3 PAT protein
MSPERRPVEIRPATAADMAAVCDMVNHYIETSTVNFRTEPQTPQEWIDDLERLQDRYPWL
VAEVEGVVAGIAYAGPWKARNAYDWTVESTVYVSHRHQRLGLGSTLYTHLLKSMEAQGFK
SVVAVIGLPNDPSVRLHEALGYTARGTLRAAGYKHGGWHDVGFWQRDFELPAPPRPVRPV
TQI
SEQ ID No. 4: BAR nucleotide
ATG AGC CCA GAA CGA CGC CCG GCC GAC
ATC CGC CGT GCC ACC GAG GCG GAC ATG
CCG GCG GTC TGC ACC ATC GTC AAC CAC
TAC ATC GAG ACA AGC ACG GTC AAC TTC
CGT ACC GAG CCG CAG GAA CCG CAG GAG
TGG ACG GAC GAC CTC GTC CGT CTG CGG
GAG CGC TAT CCC TGG CTC GTC GCC GAG
GTG GAC GGC GAG GTC GCC GGC ATC GCC
TAC GCG GGC CCC TGG AAG GCA CGC AAC
GCC TAC GAC TGG ACG GCC GAG TCG ACC
GTG TAC GTC TCC CCC CGC CAC CAG CGG
ACG GGA CTG GGC TCC ACG CTC TAC ACC
CAC CTG CTG AAG TCC CTG GAG GCA CAG
GGC TTC AAG AGC GTG GTC GCT GTC ATC
GGG CTG CCC AAC GAC CCG AGC GTG CGC
ATG CAC GAG GCG CTC GGA TAT GCC CCC
CGC GGC ATG CTG CGG GCG GCC GGC TTC
AAG CAC GGG AAC TGG CAT GAC GTG GGT
TTC TGG CAG CTG GAC TTC AGC CTG CCG
GTA CCG CCC CGT CCG GTC CTG CCC GTC
ACC GAG ATC
SEQ ID No. 5: BAR* nucleotide
ATG GAC CCA GAA CGA CGC CCG GCC GAC
ATC CGC CGT GCC ACC GAG GCG GAC ATG
CCG GCG GTC TGC ACC ATC GTC AAC CAC
TAC ATC GAG ACA AGC ACG GTC AAC TTC
CGT ACC GAG CCG CAG GAA CCG CAG GAG
TGG ACG GAC GAC CTC GTC CGT CTG CGG
GAG CGC TAT CCC TGG CTC GTC GCC GAG
GTG GAC GGC GAG GTC GCC GGC ATC GCC
TAC GCG GGC CCC TGG AAG GCA CGC AAC
GCC TAC GAC TGG ACG GCC GAG TCG ACC
GTG TAC GTC TCC CCC CGC CAC CAG CGG
ACG GGA CTG GGC TCC ACG CTC TAC ACC
CAC CTG CTG AAG TCC CTG GAG GCA CAG
GGC TTC AAG AGC GTG GTC GCT GTC ATC
GGG CTG CCC AAC GAC CCG AGC GTG CGC
ATG CAC GAG GCG CTC GGA TAT GCC CCC
CGC GGC ATG CTG CGG GCG GCC GGC TTC
AAG CAC GGG AAC TGG CAT GAC GTG GGT
TTC TGG CAG CTG GAC TTC AGC CTG CCG
GTA CCG CCC CGT CCG GTC CTG CCC GTC
ACC GAG ATC
SEQ ID No. 6: Pat
ATGAGCCCAGAACGACGCCCGGTCGAGATCCGTCCCGCCACCGCCGCCGACATGGCGGCG
GTCTGCGACATCGTCAATCACTACATCGAGACGAGCACGGTCAACTTCCGTACGGAGCCG
CAGACTCCGCAGGAGTGGATCGACGACCTGGAGCGCCTCCAGGACCGCTACCCCTGGCTC
GTCGCCGAGGTGGAGGGCGTCGTCGCCGGCATCGCCTACGCCGGCCCCTGGAAGGCCCGC
AACGCCTACGACTGGACCGTCGAGTCGACGGTGTACGTCTCCCACCGGCACCAGCGGCTC
GGACTGGGCTCCACCCTCTACACCCACCTGCTGAAGTCCATGGAGGCCCAGGGCTTCAAG
AGCGTGGTCGCCGTCATCGGACTGCCCAACGACCCGAGCGTGCGCCTGCACGAGGCGCTC
GGATACACCGCGCGCGGGACGCTGCGGGCAGCCGGCTACAAGCACGGGGGCTGGCACGAC
GTGGGGTTCTGGCAGCGCGACTTCGAGCTGCCGGCCCCGCCCCGCCCCGTCCGGCCCGTC
ACACAGATCTGA
SEQ ID No. 7: Synthetic pat
ATGTCTCCGGAGAGGAGACCAGTTGAGATTAGGCCAGCTACAGCAGCTGATATGGCCGCG
GTTTGTGATATGGTTAACCATTACATTGAGACGTCTACAGTGAACTTTAGGACAGAGCCA
CAAACACCACAAGAGTGGATTGATGATCTAGAGAGGTTGCAAGATAGATACCCTTGGTTG
GTTGCTGAGGTTGAGGGTGTTGTGGCTGGTATTGCTTACGCTGGGCCCTGGAAGGCTAGG
AACGCTTACGATTGGACAGTTGAGAGTACTGTTTACGTGTCACATAGGCATCAAAGGTTG
GGCCTAGGATCCACATTGTACACACATTTGCTTAAGTCTATGGAGGCGCAAGGTTTTAAG
TCTGTGGTTGCTGTTATAGGCCTTCCAAACGATCCATCTGTTAGGTTGCATGAGGCTTTG
GGATACACAGCCCGGGGTACATTGCGCGCAGCTGGATACAAGCATGGTGGATGGCATGAT
GTTGGTTTTTGGCAAAGGGATTTTGAGTTGCCAGCTCCTCCAAGGCCAGTTAGGCCAGTT
ACCCAGATCTGA

In a particular embodiment, glufosinate tolerant plants are plants which comprise and express a gene comprising the following operably linked DNA fragments:
a) a plant expressible promoter;
b) a DNA region encoding a protein with phosphinotricin acetyltransferase activity comprising an amino acid sequence having at least 90% or at least 91%, or at least 92%, or at least 93%, or at least 94%, or at least 95%, or at least 96%, or at least 97%, or at least 98%, or at least 99% sequence identity or is identical with the amino acid of SEQ ID NO. 1 (BAR protein from Streptomyces hygroscopicus); and
c) optionally, a transcription termination and polyadenylation region functional in plant cells.

In another embodiment, glufosinate tolerant plants are plants which comprise and express a gene comprising the following operably linked DNA fragments:
a) a plant expressible promoter;
b) a DNA region encoding a protein with phosphinotricin acetyltransferase activity comprising the amino acid of SEQ ID NO. 2 (BAR protein variant described in WO 87/05629); and
c) optionally, a transcription termination and polyadenylation region functional in plant cells.

In yet another embodiment, glufosinate tolerant plants are plants which comprise and express a gene comprising the following operably linked DNA fragments:
a) a plant expressible promoter;
b) a DNA region encoding a protein with phosphinotricin acetyltransferase activity comprising an amino acid sequence having at least 90% or at least 91%, or at least 92%, or at least 93%, or at least 94%, or at least 95%, or at least 96%, or at least 97%, or at least 98%, or at least 99% sequence identity or is identical with the amino acid of SEQ ID NO. 3 (PAT protein from Streptomyces viridichromogenes); and
c) optionally, a transcription termination and polyadenylation region functional in plant cells.

In still another embodiment, glufosinate tolerant plants are plants which comprise and express a gene comprising the following operably linked DNA fragments:
a) a plant expressible promoter;
b) a DNA region encoding a protein with phosphinotricin acetyltransferase activity, said DNA region comprising a nucleotide sequence having at least 90% or at least 91%, or at least 92%, or at least 93%, or at least 94%, or at least 95%, or at least 96%, or at least 97%, or at least 98%, or at least 99% sequence identity or is identical with the nucleotide sequence of SEQ ID NO. 4 (bar coding region from S. hygroscopicus); and
c) optionally, a transcription termination and polyadenylation region functional in plant cells.

In a particular embodiment, glufosinate tolerant plants are plants which comprise and express a gene comprising the following operably linked DNA fragments:
a) a plant expressible promoter;
b) a DNA region encoding a protein with phosphinotricin acetyltransferase activity, said DNA region comprising the nucleotide sequence of SEQ ID NO. 5 (bar coding region variant described in WO 87/05629); and
c) optionally, a transcription termination and polyadenylation region functional in plant cells.

In still another embodiment, glufosinate tolerant plants are plants which comprise and express a gene comprising the following operably linked DNA fragments:
a) a plant expressible promoter;
b) a DNA region encoding a protein with phosphinotricin acetyltransferase activity, said DNA region comprising a nucleotide sequence having at least 90% or at least 91%, or at least 92%, or at least 93%, or at least 94%, or at least 95%, or at least 96%, or at least 97%, or at least 98%, or at least 99% sequence identity or is identical with the nucleotide sequence of SEQ ID NO. 6 (pat coding region from S. virdochromogenes); and
c) optionally, a transcription termination and polyadenylation region functional in plant cells.

In a particular embodiment, glufosinate tolerant plants are plants which comprise and express a gene comprising the following operably linked DNA fragments:
a) a plant expressible promoter;
b) a DNA region encoding a protein with phosphinotricin acetyltransferase activity, said DNA region comprising the nucleotide sequence of SEQ ID NO. 7 (synthetic pat coding region described in U.S. Pat. No. 5,276,268); and
c) optionally, a transcription termination and polyadenylation region functional in plant cells.

In another embodiment, glufosinate tolerant plants are plants which contain any one or more of the following events comprising a pat coding sequence under control of a plant expressible promoter:

Event 32316 in CORN plants (OECD number: DP-032316-8) for INSECT CONTROL—HERBICIDE TOLERANCE deposited as ATCC PTA-11507 described in patent publication WO 2011/084632

Event 40416 in CORN plants (OECD number: DP-040416-8) for INSECT CONTROL—HERBICIDE TOLERANCE deposited as ATCC PTA-11508 described in patent publication WO 2011/075593

Event 4114 in CORN plants (OECD number: DP-004114-3) for INSECT CONTROL—HERBICIDE TOLERANCE deposited as ATCC PTA-11506 described in patent publication WO 2011/084621

Event 43A47 in CORN plants (OECD number: DP-043A47-3) for INSECT CONTROL—HERBICIDE TOLERANCE deposited as ATCC PTA-11509 described in patent publication WO 2011/075595

Event 676 in CORN plants (OECD number: PH-000676-7) for POLLINATION CONTROL—HERBICIDE TOLERANCE described in regulatory reference US 97-342-01p

Event 678 in CORN plants (OECD number: PH-000678-9) for POLLINATION CONTROL—HERBICIDE TOLERANCE described in regulatory reference US 97-342-01p

Event 680 in CORN plants (OECD number: PH-000680-2) for POLLINATION CONTROL—HERBICIDE TOLERANCE described in regulatory reference US 97-342-01p

Event BT11 in CORN plants (OECD number: SYN-BT011-1) for INSECT CONTROL—HERBICIDE TOLERANCE described in regulatory reference US 95-195-01p

Event DAS-59122-7 in CORN plants (OECD number: DAS-59122-7) for INSECT CONTROL—HERBICIDE TOLERANCE deposited as ATCC PTA-11384 described in patent publication US 2008/0178323 or described in regulatory reference US 03-353-01p

Event T14 in CORN plants (OECD number: ACS-ZMO02-1) for HERBICIDE TOLERANCE described in regulatory reference US 94-357-14p

Event T25 in CORN plants (OECD number: ACS-ZMO03-2) for HERBICIDE TOLERANCE described in patent publication WO 2001/051654 or described in regulatory reference US 94-357-01p

Event TC1507 in CORN plants (OECD number: DAS-01507-1) for INSECT CONTROL—HERBICIDE TOLERANCE described in patent publication US 2009/0170109 or described in regulatory reference US 00-136-0p

Event VIP1034 in CORN plants for INSECT CONTROL - HERBICIDE TOLERANCE deposited as ATCC PTA-3925 described in patent publication WO 2003/052073

Event MON87419 in CORN plants for HERBICIDE TOLERANCE deposited as ATCC PTA-120860 described in patent publication WO 2015/142571

Event 281-24-236 in COTTON plants (OECD number: DAS-24236-5) for INSECT CONTROL—HERBICIDE TOLERANCE deposited as ATCC PTA-6233 described in patent publication US 2005/0216969 or described in regulatory reference US 03-036-01p

Event 3006-210-23 in COTTON plants (OECD number: DAS-21023-5) for INSECT CONTROL—HERBICIDE TOLERANCE deposited as ATCC PTA-6233 described in patent publication US 2005/0216969 or described in regulatory reference CA DD2005-51

Event DAS1910 in COTTON plants (OECD number: DAS-81910-7) for HERBICIDE TOLERANCE

Event pDAB4468.18.07.1 in COTTON plants for HERBICIDE TOLERANCE

Event pDAB4468.19.10.3 in COTTON plants for HERBICIDE TOLERANCE

Event GS40/90pHoe6/Ac in OILSEED RAPE plants (OECD number: ACS-BN010-4) for HERBICIDE TOLERANCE

Event HCN10 in OILSEED RAPE plants for HERBICIDE TOLERANCE described in regulatory reference US 01-206-02p

Event HCN92 in OILSEED RAPE plants (OECD number: ACS-BN007-1) for HERBICIDE TOLERANCE described in regulatory reference CA DD95-01

Event ATBT04-27 in POTATO plants (OECD number: NMK-89367-8) for INSECT CONTROL described in regulatory reference US 95-338-01p

Event ATBT04-30 in POTATO plants (OECD number: NMK-89613-2) for INSECT CONTROL described in regulatory reference US 95-338-01p

Event ATBT04-31 in POTATO plants (OECD number: NMK-89170-9) for INSECT CONTROL described in regulatory reference US 95-338-01p

Event ATBT04-36 in POTATO plants (OECD number: NMK-89279-1) for INSECT CONTROL described in regulatory reference US 95-338-01p

Event ATBT04-6 in POTATO plants (OECD number: NMK-89761-6) for INSECT CONTROL described in regulatory reference US 95-338-01p

Event 9582.814.19.1 in SOYBEAN plants (OECD number: DAS-81419-2) for INSECT CONTROL—HERBICIDE TOLERANCE deposited as ATCC PTA-12006 described in patent publication WO 2013/016527 or described in regulatory reference US 12-2′72-01p

Event DAS21606 in SOYBEAN plants (OECD number: DAS-21606-3) for HERBICIDE TOLERANCE deposited as ATTC PTA-11028 described in patent publication WO 2012/033794

Event DAS44406 in SOYBEAN plants (OECD number: DAS-44406-6) for HERBICIDE TOLERANCE deposited as PTA-11336 described in patent publication WO 2012/075426

Event DAS68416 in SOYBEAN plants (OECD number: DAS-68416-4) for HERBICIDE TOLERANCE deposited as ATCC PTA-10442 described in patent publication WO 2011/066360 or described in regulatory reference US 09-349-01p

Event GU262 in SOYBEAN plants (OECD number: ACS-GM003-1) for HERBICIDE TOLERANCE described in regulatory reference US 98-238-01p

Event GU262 in SOYBEAN plants (OECD number: ACS-GM003-1) for HERBICIDE TOLERANCE described in regulatory reference US 96-086-01p

Event LL27 in SOYBEAN plants (OECD number: ACS-GM005-3) for HERBICIDE TOLERANCE deposited as NCIMB41658 described in patent publication US 2008/0320616 or described in regulatory reference US 96-068-01p

Event LL55 in SOYBEAN plants (OECD number: ACS-GM006-4) for HERBICIDE TOLERANCE deposited as NCIMB 41660 described in patent publication WO 2006/108675 or described in regulatory reference US 98-014-01p

Event pDAB8264.44.06.1 in SOYBEAN plants (OECD number: DAS-44406-6) for HERBICIDE TOLERANCE deposited as ATCC Accession N° PTA-11336 described in patent publication WO 2012/075426A1 or described in regulatory reference US 11-234-01p

Event T-120-7 in SUGAR BEET plants (OECD number: ACS-BV001-3) for HERBICIDE TOLERANCE described in regulatory reference US 97-336-01p

In yet another embodiment, glufosinate tolerant plants are plants which contain the any one or more of the following events comprising a bar coding sequence under control of a plant expressible promoter:

Event B16 in CORN plants (OECD number: DKB-89790-5) for HERBICIDE TOLERANCE deposited as ATCC 203059 described in patent publication US 2003/0126634 or described in regulatory reference US95-145-01p

Event BT176 in CORN plants (OECD number: SYN-EV176-9) for INSECT CONTROL—HERBICIDE TOLERANCE described in regulatory reference US94-319-01p

Event CBH351 in CORN plants (OECD number: ACS-ZMO04-3) for INSECT CONTROL—HERBICIDE TOLERANCE described in regulatory reference US97-265-01p

Event DBT418 in CORN plants (OECD number: DKB-89614-9) for INSECT CONTROL—HERBICIDE TOLERANCE described in regulatory reference US96-291-01p

Event MS3 in CORN plants (OECD number: ACS-ZMO01-9) for POLLINATION CONTROL—HERBICIDE TOLERANCE described in regulatory reference US 95-228-01p

Event MS6 in CORN plants (OECD number: ACS-ZMO05-4) for POLLINATION CONTROL—HERBICIDE TOLERANCE described in regulatory reference US 95-228-01p

Event TC6275 in CORN plants (OECD number: DAS-06275-8) for INSECT CONTROL—HERBICIDE TOLERANCE described in regulatory reference US 00-136-01p

Event GHB119 in COTTON plants (OECD number: BCS-GH005-8) for INSECT CONTROL—HERBICIDE TOLERANCE deposited as ATCC PTA-8398 described in patent publication WO 2008/151780 or described in regulatory reference US 08-340-01p

Event LLcotton25 in COTTON plants (OECD number: ACS-GH001-3) for HERBICIDE TOLERANCE deposited as ATCC PTA-3343 described in patent publication WO 2003/013224 or described in regulatory reference US 02-042-01p

Event MON88701 in COTTON plants (OECD number: MON-88701-3) for HERBICIDE TOLERANCE deposited as ATCC PTA-11754 described in patent publication US 2012/0255050 or described in regulatory reference US 12-CTU-244U

Event T304-40 in COTTON plants (OECD number: BCS-GH004-7) for INSECT CONTROL—HERBICIDE TOLERANCE deposited as ATCC PTA-8171 described in patent publication WO 2008/122406

Event MSI in OILSEED RAPE plants (OECD number: ACS-BN004-7) for POLLINATION CONTROL—HERBICIDE TOLERANCE or described in regulatory reference US 98-279-01p

Event MS11 in OILSEED RAPE plants) for POLLINATION CONTROL—HERBICIDE TOLERANCE deposited as ATCC PTA-850 or PTA-2485 described in patent publication WO 2001/031042

Event MS8 in OILSEED RAPE plants (OECD number: ACS-BN005-8) for POLLINATION CONTROL—HERBICIDE TOLERANCE deposited as ATCC PTA-730 described in patent publication US 2001/0029620 or described in regulatory reference US 98-278-01p

Event RF1 in OILSEED RAPE plants (OECD number:ACS-BN001-4) for POLLINATION CONTROL—HERBICIDE TOLERANCE described in regulatory reference US01-206-01p

Event RF2 in OILSEED RAPE plants (OECD number:ACS-BN002-5) for POLLINATION CONTROL—

HERBICIDE TOLERANCE described in regulatory reference US98-27-01p

Event RF3 in OILSEED RAPE plants (OECD number: ACS-BN003-6) for POLLINATION CONTROL—HERBICIDE TOLERANCE deposited as ATCC PTA-730 described in patent publication WO 2001/041558 or described in regulatory reference US01-206-01p

Event LLRICE06 in RICE plants (OECD number: ACS-OS001-4) for HERBICIDE TOLERANCE deposited as ATCC-23353 described in patent publication WO 2000/026356 or described in regulatory reference US98-329-01p

Event LLRICE601 in RICE plants (OECD number: BCS-05003-7) for HERBICIDE TOLERANCE deposited as ATCC PTA-2600 described in patent publication US 2008/0289060 or described in regulatory reference US06-234-01p

Event LLRICE62 in RICE plants (OECD number: ACS-05002-5) for HERBICIDE TOLERANCE deposited as ATCC-203352 described in patent publication WO 2000/026345or described in regulatory reference US98-329-01p

Event SYHT04R in SOYBEAN plants (OECD number: SYN-0004R-8) for HERBICIDE TOLERANCE

Event W62 in SOYBEAN plants (OECD number: ACS-GM002-9) for HERBICIDE TOLERANCE described in regulatory reference US 96-068-01p

Event W98 in SOYBEAN plants (OECD number: ACS-GM001-8) for HERBICIDE TOLERANCE described in regulatory reference US 96-068-01p

Preferred glufosinate tolerant field crops in the context of the present invention are selected from the group consisting of soybean, cotton, oilseed rape, maize (corn) and sweet corn.

Particularly preferred in the context of the present invention are glufosinate tolerant field plants comprising one of the following events:

Event LL27 in SOYBEAN plants (OECD number: ACS-GM005-3) for HERBICIDE TOLERANCE deposited as NCIMB41658 described in patent publication US 2008/0320616 or described in regulatory reference US 96-068-01p

Event LL55 in SOYBEAN plants (OECD number: ACS-GM006-4) for HERBICIDE TOLERANCE deposited as NCIMB 41660 described in patent publication WO 2006/108675 or described in regulatory reference US 98-014-01p

Event LLcotton25 in COTTON plants (OECD number: ACS-GH001-3) for HERBICIDE TOLERANCE deposited as ATCC PTA-3343 described in patent publication WO 2003/013224 or described in regulatory reference US 02-042-01p

Event GS40/90pHoe6/Ac in OILSEED RAPE plants (OECD number: ACS-BN010-4) for HERBICIDE TOLERANCE

Event HCN92 in OILSEED RAPE plants (OECD number: ACS-BN007-1) for HERBICIDE TOLERANCE described in regulatory reference CA DD95-01

Event MS1 in OILSEED RAPE plants (OECD number: ACS-BN004-7) for POLLINATION CONTROL—HERBICIDE TOLERANCE or described in regulatory reference US 98-2′79-01p

Event MS8 in OILSEED RAPE plants (OECD number: ACS-BN005-8) for POLLINATION CONTROL—HERBICIDE TOLERANCE deposited as ATCC PTA-730 described in patent publication US 2001/0029620 or described in regulatory reference US 98-2′78-01p

Event RF1 in OILSEED RAPE plants (OECD number:ACS-BN001-4) for POLLINATION CONTROL—HERBICIDE TOLERANCE described in regulatory reference US01-206-01p

Event RF2 in OILSEED RAPE plants (OECD number:ACS-BN002-5) for POLLINATION CONTROL—HERBICIDE TOLERANCE described in regulatory reference US98-27-01p

Event RF3 in OILSEED RAPE plants (OECD number: ACS-BN003-6) for POLLINATION CONTROL—HERBICIDE TOLERANCE deposited as ATCC PTA-730 described in patent publication WO 2001/041558 or described in regulatory reference US01-206-01p

As shown in the example section below, the effects described in the context of the present invention were observed in field trials using the following varieties:

Soybean (GLXMA) variety: CZ5515LL (Bayer); CZ5515LL is a soybean variety which offers tolerance to glufosinate herbicides and superior southern stem canker protection.

Cotton (GOSHI) variety: ST 4747GLB2 (Bayer); Stoneville ST 4747GLB2 is a multiple-herbicide stacked cotton variety which offers tolerance to both glyphosate and glufosinate herbicides.

Corn (ZEAMX) variety: P1142avix^{TM} (DuPont Pioneer); P1142_{A}mx^{Tm} corn offers tolerance to both glyphosate and glufosinate herbicides as well as an insect protection system.

Oilseed rape (BRSNS) variety: InVigor® L140P (Bayer); InVigor® L140P canola is tolerant to glufosinate herbicides and has pod shatter reduction technology.

Preferably, the composition as defined in the context of the present invention is used in foliar application at a relative humidity of 50% or above, preferably of 55% or above, more preferably of 60% or above, and even more preferably of 70% or above.

In preferred compositions used in accordance with the present invention, the total amount of L-glufosinate and/or agronomically acceptable salts thereof is equal to or less than 600 g/L (g/L =gram per litre), more preferably is equal to or less than 450 g/L, and even more preferably is equal to or less than 350 g/L, in each case based on the total amount of the composition.

Preferably, the total amount of L-glufosinate and/or agronomically acceptable salts thereof in a composition used in accordance with the present invention in the range of from 50 to 600 g/L, preferably in the range of from 100 to 400 g/L, and more preferably in the range of from 150 to 350 g/L, in each case based on the total amount of the composition.

L-Glufosinate employed in the context of the present invention may be used in the form of the respective agronomically acceptable salts, in particular as alkali metal salts, alkaline earth salts or ammonium salts.

Glufosinate (IUPAC-Name: (2RS)-2-amino-4-[hydroxy(methyfiphosphinoyl]butyric acid or 4-[hydroxy(methyl)phosphinoyl]-DL-homoalanine, CAS Reg. No. 51276-47-2) and agronomically acceptable salts thereof are known, in particular glufosinate-ammonium (IUPAC-Name: ammonium (2RS)-2-amino-4-(methylphosphinato)butyric acid, CAS Reg. No. 77182-82-2).

Glufosinate is represented by the following structure (1):

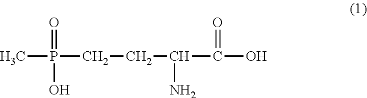

The compound of formula (1) is a racemate.

In the context of the present invention, the term “L-glufosinate” only relates to the L-enantiomer of glufosinate.

Preferably, the agronomically acceptable salts of L-glufosinate are the sodium, potassium or ammonium (NH₄⁺) salts of L-glufosinate, in particular glufosinate-P-ammonium and glufosinate-P-sodium, i.e. glufosinate-P-ammonium (IUPAC-Name: ammonium (2S)-2-amino-4-(methylphosphinato)butyric acid, CAS Reg. No. 73777-50-1), and glufosinate-P-sodium (IUPAC-Name: sodium (2S)-2-amino-4-(methylphosphinato)butyric acid; CAS Reg. No. 70033-13-5).

L-glufosinate can be obtained commercially, or may be prepared for example as described in EP0248357A2, EP0249188A2, EP0344683A2, EP0367145A2, or EP0477902A2.

In accordance with the present invention, the compositions defined and used herein comprise a herbicidally effective amount of L-glufosinate and/or agronomically acceptable salts thereof and can be used together with other agrochemically active compounds, for example from the group of the safeners, fungicides, insecticides, other herbicides and other plant growth regulators, or with formulation auxiliaries and additives customary in crop protection. Additives are, for example, fertilizers and colorants.

In the context of the present invention, the term “further herbicidal active ingredient” and “further agrochemically active compound” refers to the herbicides and agrochemically active compounds (pesticides), respectively, listed in “The Pesticide Manual”, 16th edition, The British Crop Protection Council and the Royal Soc. of Chemistry, 2012 other than glufosinate and agronomically acceptable salts thereof.

Preferably, the composition comprising a herbicidally effective amount of L-glufosinate and/or agronomically acceptable salts thereof as defined in the context of the present invention additionally contains water, one or more organic solvents and one or more surfactants.

In the context of the present invention L-glufosinate and/or agronomically acceptable salts thereof are preferably selected from the group consisting of L-glufosinate, L-glufosinate-ammonium, L-glufosinate-potassium, and L-glufosinate-sodium, and more preferably L-glufosinate-ammonium or L-glufosinate-sodium.

Preferably compositions are used in the context of the present invention, wherein the only herbicide in the composition is glufosinate and/or agronomically acceptable salts thereof, i.e. wherein no further herbicidally active ingredients are present in the composition used.

Preferably, L-glufosinate and/or agronomically acceptable salts thereof is used in the context of the present invention in a total amount per year in the range of from 100 to 1200 g/ha, preferably in the range of from 150 to 600 g/ha, more preferably in the range of from 200 to 500 g/ha, even more preferably in the range of from 250 to 450 g/ha.

Preferably, the compositions as defined and used in the context of the present invention are applied to the harmful plants at growth stages in the range of BBCH 10 to BBCH 30, more preferably to the harmful plants at growth stages in the range of BBCH 11 to BBCH 20.

In a preferred embodiment, the compositions as defined and used in the context of the present invention are applied once, twice or three times within a glufosinate tolerant field cropping cycle, i.e. one application, two applications or three applications per glufosinate tolerant field cropping cycle can be made. Corn, soybeans, cotton, and canola are considered as glufosinate tolerant field crops and typically take not more than 7 months from seeding until ripeness (and thus harvestability) of the glufosinate tolerant field crop. This period is also called glufosinate tolerant field cropping cycle. Depending on the climatic region where the glufosinate tolerant field crop is grown one or two glufosinate tolerant field crops can be raised during a 12 months period, i.e. one or two glufosinate tolerant field cropping cycles can be accomplished during a 12 months period.

In a preferred embodiment, the compositions as defined and used in the context of the present invention are applied twice time per glufosinate tolerant field cropping cycle (as defined above), i.e. in two applications per glufosinate tolerant field cropping cycle can be made.

In an alternatively preferred embodiment, the compositions as defined and used in the context of the present invention are applied one time per glufosinate tolerant field cropping cycle (as defined above), i.e. one application per glufosinate tolerant field cropping cycle can be made.

The compositions as defined in the context of the present invention are used in foliar, i.e. post-emergence application.

The compositions as defined and used in the context of the present invention have an outstanding herbicidal activity against a broad spectrum of economically important harmful monocotyledonous and dicotyledonous harmful plants.

Specifically, examples may be mentioned of some representatives of the monocotyledonous and dicotyledonous weed flora which can be controlled by the compositions as defined and used in the context of the present invention, without the enumeration being a restriction to certain species.

Examples of monocotyledonous harmful plants on which the compositions as defined and used in the context of the present invention act efficiently are from amongst the genera Hordeum spp., Echinochloa spp., Poa spp., Bromus spp., Digitaria spp., Eriochloa spp., Setaria spp., Pennisetum spp., Eleusine spp., Eragrostis spp., Panicum spp., Lolium spp., Brachiaria spp., Leptochloa spp., Avena spp., Cyperus spp., Axonopris spp., Sorghum spp., and Melinus spp.

Particular examples of monocotyledonous harmful plants species on which the compositions as defined and used in the context of the present invention act efficiently are selected from from amongst the species Hordeum murinum, Echinochloa crus-galli, Poa annua, Bromus rubens L., Bromus rigidus, Bromus secalinus L., Digitaria sanguinalis, Eriochloa gracilis, Setaria faberi, Setaria viridis, Pennisetum glaucum, Eleusine indica, Eragrostis pectinacea, Panicum miliaceum, Lolium multiflorum, Brachiaria platyphylla, Leptochloa fusca, Avena fatua, Cyperus compressus, Cyperus esculentes, Axonopris offinis, Sorghum halapense, and Melinus repens.

Examples of dicotyledonous harmful plants on which the compositions as defined and used in the context of the present invention act efficiently are from amongst the genera Amaranthus spp., Polygonum spp., Medicago spp., Mollugo spp., Cyclospermum spp., Stellaria spp., Gnaphalium spp., Taraxacum spp., Oenothera spp., Amsinckia spp., Erodium spp., Erigeron spp., Senecio spp., Lamium spp., Kochia spp., Chenopodium spp., Lactuca spp., Malva spp., Ipomoea spp., Brassica spp., Sinapis spp., Urtica spp., Sida spp, Portulaca spp., Richardia spp., Ambrosia spp., Calandrinia spp., Sisymbrium spp., Sesbania spp., Capsella spp., Sonchus spp., Euphorbia spp., Helianthus spp., Coronopus spp., Salsola spp., Abutilon spp., Vicia spp., Epilobium spp., Cardamine spp., Picris spp., Trifolium spp., Galinsoga spp., Epimedium spp., Marchantia spp., Solanum spp., Oxalis spp., Metricaria spp., Plantago spp., Tribulus spp., Cenchrus spp. Bidens spp., Veronica spp., and Hypochaeris spp.

Particular examples of dicotyledonous harmful plants species on which the compositions as defined and used in the context of the present invention act efficiently are selected from from amongst the species Amaranthus spinosus, Polygonum convolvulus, Medicago polymorpha, Mollugo verticillata, Cyclospermum leptophyllum, Stellaria media, Gnaphalium purpureum, Taraxacum offi cinale, Oenothera laciniata, Amsinckia intermedia, Erodium cicutarium, Erodium moschatum, Erigeron bonariensis, Senecio vulgaris, Lamium amplexicaule, Erigeron canadensis, Polygonum aviculare, Kochia scoparia, Chenopodium album, Lactuca serriola, Malva parviflora, Malva neglecta, Ipomoea hederacea, Ipomoea lacunose, Brassica nigra, Sinapis arvensis, Urtica dioica, Amaranthus palmeri, Amaranthus blitoides, Amaranthus retroflexus, Amaranthus hybridus, Amaranthus lividus, Amaranthus tuberculatus, Sida spinosa, Portulaca oleracea, Richardia scabra, Ambrosia artemisiifolia, Calandrinia caulescens, Sisymbrium irio, Sesbania exaltata, Capsella bursa-pastoris, Sonchus oleraceus, Euphorbia maculate, Helianthus annuus, Coronopus didymus, Salsola tragus, Abutilon theophrasti, Trianthema portulacastrum, Vicia benghalensis L., Epilobium paniculatum, Cardamine spp, Picris echioides, Trifolium spp., Galinsoga spp., Epimedium spp., Marchantia spp., Solanum spp., Oxalis spp., Metricaria matriccarioides, Plantago spp., Tribulus terrestris, Salsola kali, Cenchrus spp., Bidens bipinnata, Veronica spp., and Hypochaeris radicata.

As shown in the biological examples hereinbelow, for example the following harmful plants or undesired plants are controlled in a more effective and superior manner by application of the compositions as defined and used in the context of the present invention when compared to racemic glufosinate: Amaranthus palmeri, Abutilon theophrasti and Trianthema portulacastrum.

When the compositions as defined and used in the context of the present invention are applied post-emergence to the green parts of the plants, growth likewise stops drastically a very short time after the treatment and the weed plants remain at the growth stage of the point of time of application, or they die completely after a certain time, so that in this manner competition by the weeds, which is harmful to the crops, is eliminated at a very early point in time and in a sustained manner.

The present invention also relates to a method of controlling undesired vegetation (e.g. harmful plants), which comprises applying compositions as defined and used in the context of the present invention by the post-emergence method to harmful or undesired plants, parts of said harmful or undesired plants, or the area where the harmful or undesired plants grow, for example the area under cultivation.

In the context of the present invention “controlling” denotes a significant reduction of the growth of the harmful plant(s) in comparison to the untreated harmful plants. Preferably, the growth of the harmful plant(s) is essentially diminished (60-79%), more preferably the growth of the harmful plant(s) is largely or fully suppressed (80-100%), and in particular the growth of the harmful plant(s) is almost fully or fully suppressed (90-100%).

In a preferred embodiment, when using a composition comprising a herbicidally effective amount of L-glufosinate and/or agronomically acceptable salts thereof as defined in the context of the present invention

(i) the herbicidal activity is increased by 3% or more, in comparison to a composition comprising twice the molar amount of racemic glufosinate and/or salts thereof,

and/or

(ii) the crop damage is reduced by 10% or more, preferably by 20% or more, in comparison to a composition comprising the same molar amount of racemic glufosinate and/or salts thereof,

in each case when assessed 5 to 14 days after application of the composition.

In a more preferred embodiment, when using a composition comprising a herbicidally effective amount of L-glufosinate and/or agronomically acceptable salts thereof as defined in the context of the present invention

(i) the herbicidal activity is increased by 3% or more,

and/or

(ii) the crop damage is reduced by 10% or more, preferably by 20% or more,

in each case when assessed 5 to 14 days after application of the composition and in comparison to a composition comprising twice the molar amount of racemic glufosinate and/or salts thereof.

As already mentioned above, in a further aspect, the present invention relates to a method for controlling harmful plants in a glufosinate tolerant field crop, including the following steps:

(a) providing a composition comprising L-glufosinate and/or salts thereof, wherein the composition contains less than 5 mol.-% of D-glufosinate and/or agronomically acceptable salts thereof, based on the total amount of L-glufosinate and salts thereof, preferably a composition as defined and used in one or more of the preferred embodiments defined in the context of the present invention, and optionally diluting said composition with water,

(b) foliar application of a herbicidally effective amount of the composition of step (a) to harmful plants and a glufosinate tolerant field crop,

wherein the composition is applied at an air temperature of 18° C. or above, preferably of 21° C. or above, and more preferably of 24° C. or above, in each case when measured 2 m above the ground.

The preferred application rates [indicated as g/ha i.e. grams of active ingredient per hectare] used in the context of the present invention as defined herein are as follows.

In a preferred method or use according to the present invention, the total amount per glufosinate tolerant field cropping cycle per hectare of L-glufosinate and the agronomically acceptable salts thereof does not exceed 1800 g, and preferably does not exceed 1200 g.

In many cases it is preferred in the context of a method or use according to the present invention that the total amount per glufosinate tolerant field cropping cycle per hectare of L-glufosinate and the agronomically acceptable salts thereof does not exceed 750 g, and more preferably does not exceed 600 g.

Herbicidal formulations comprising L-glufosinate or salts thereof (preferred salts being L-glufosinate-ammonium and L-glufosinate-sodium), are known in the art, for example, from EP 0048436, EP 0336151 A2,

U.S. Pat. Nos. 5,258,358, 5,491,125, US 2005/0266995 A1, US 2005/0266998 A1, US 2005/266999 A1, US 2007/0184982 A1 or US 2008/0045415 A1, and such formulations are suitable compositions (and/or concentrates for obtaining compositions) in the context of the present invention.

Preferably, the compositions used or applied in the context of the present invention comprise or consist of
(a) glufosinate and/or salts thereof containing less than 5 mol.-% of D-glufosinate and/or salts thereof, based on the total amount of L-glufosinate and salts thereof,
(b) water,
(c) one or more organic solvents,
(d) one or more surfactants, preferably one or more nonionic, cationic, anionic and/or zwitterionic surfactants, and optionally one, two, three or more further constituents selected from the following groups (e) to (g),
(e) inorganic salts (preferably ammonium salts),
(f) further agrochemically active compounds different from constituent (a), i.e. not glufosinate and/or salts thereof,
(g) other formulation adjuvants.

In connection with the present invention the term “organic solvents” (constituent (c) of a composition for use in accordance with the present invention) includes, for example, nonpolar organic solvents, polar protic organic solvents or aprotic organic polar solvents and mixtures thereof. Examples of organic solvents in the sense ofthe invention are
aliphatic or aromatic hydrocarbons, such as mineral oils and toluene, xylenes and naphthalene derivatives, for example,
halogenated aliphatic or aromatic hydrocarbons such as methylene chloride and chlorobenzene;
aliphatic alcohols, such as alkanols having 1 to 12 carbon atoms, preferably 1 to 6 carbon atoms, such as methanol, ethanol, propanol, isopropanol and butanol, for example, or polyhydric alcohols such as ethylene glycol, propylene glycol and glycerol;
ethers such as diethyl ether, tetrahydrofuran (THF), and dioxane;
alkylene glycol monoalkyl and dialkyl ethers, such as propylene glycol monomethyl ether, propylene glycol monoethyl ether, ethylene glycol monomethyl and monoethyl ether, diglyme, and tetraglyme, for example;
amides such as dimethylformamide (DMF), dimethylacetamide, dimethylcaprylamide, dimethylcapramide (®Hallcomide), and N-alkylpyrrolidones;
ketones such as acetone;
esters based on glyceryl and carboxylic acids, such as glyceryl mono-, di- and triacetate,
phthalic esters;
lactams;
carbonic diesters;
nitriles such as acetonitrile, propionitrile, butyronitrile, and benzonitrile;
sulfoxides and sulfones such as dimethyl sulfoxide (DMSO) and sulfolane;
oils, examples being plant-based oils such as corn germ oil, rapeseed oil or soybean oil.

In many cases combinations of two or more different solvents, such as combinations containing alcohols such as methanol, ethanol, n- and isopropanol, and n-, iso-, tert- and 2-butanol, are also suitable.

Preferred organic solvents in the sense of the present invention are aromatic solvents such as toluene, o-, m- or p-xylene and mixtures thereof, 1-methylnaphthalene, 2-methylnaphthalene, C₆-C₁₆ aromatics mixtures such as, for example, the Solvesso® series (ESSO) with the grades Solvesso® 100 (b.p. 162-177° C.), Solvesso® 150 (b.p. 187-207° C.), and Solvesso® 200 (b.p. 219-282° C.), phthalic acid (C₁-C₁₂)alkyl esters, especially phthalic acid (C₄-C₈) alkyl esters, water-immiscible ketones, such as cyclohexanone or isophorone, for example, or C₆-C₂₀ aliphatics, which may be linear or cyclic, such as the products of the Shellsol® series, grades T and K, or BP-n paraffins, and esters such as glyceryl triacetate.

Particular preference is given to polar organic solvents, preferably polar organic solvents of substantial or unlimited miscibility with water which are suitable for preparing a single-phase aqueous solution. These preferably are selected from the group consisting of N-methylpyrrolidone (NMP), propylene glycol monomethyl ether (e.g. Dowanol® PM), dimethylformamide (DMF), dimethylacetamide (DMA), THF (tetrahydrofuran), propylene glycol, dipropylene glycol, glycerol, iso-propanol, and tetrahydrofurfuryl alcohol.

The compositions for use according to the present invention preferably comprise surfactants (surface-active compounds) as constituent (d), preferably one or more anionic, cationic or zwitterionic and/or nonionic surfactants. The surfactants contribute to improved stability, availability or activity of the active ingredient (a) and optionally (f).

Preferably, a composition for use in accordance with the present invention comprises one or more anionic surfactants, preferably one or more anionic surfactants and one or more nonionic surfactants.

Examples of suitable anionic surfactants are (where EO=ethylene oxide units, PO=propylene oxide units and BO=butylene oxide units):
d1-1) anionic derivatives of fatty alcohols having 10-24 carbon atoms with 0-60 EO and/or 0-20 PO and/or 0-15 BO in any order, in the form of ether carboxylates, sulfonates, sulfates, and phosphates, and their inorganic salts (e.g., alkali metal and alkaline earth metal salts) and organic salts (e.g., salts based on amine or alkanolamine), such as Genapol LRO, Sandopan® grades, and Hostaphat/Hordaphos® grades from Clariant;
d1-2) anionic derivatives of copolymers consisting of EO, PO and/or BO units having a molecular weight of 400 to 10⁸, in the form of ether carboxylates, sulfonates, sulfates, and phosphates, and their inorganic salts (e.g., alkali metal and alkaline earth metal salts) and organic salts (e.g., salts based on amine or alkanolamine),
d1-3) anionic derivatives of alkylene oxide adducts of Ci-C9 alcohols, in the form of ether carboxylates, sulfonates, sulfates and phosphates, and their inorganic salts (e.g., alkali metal and alkaline earth metal salts) and organic salts (e.g., salts based on amine or alkanolamine);
d1-4) anionic derivatives of fatty acid alkoxylates, in the form of ether carboxylates, sulfonates, sulfates and phosphates, and their inorganic salts (e.g., alkali metal and alkaline earth metal salts) and organic salts (e.g., salts based on amine or alkanolamine).

Preferred anionic surfactants are

alkyl polyglycol ether sulfates, especially fatty alcohol diethylene glycol ether sulfate (e.g., Genapol LRO®, Clariant), or

alkyl polyglycol ether carboxylates (e.g., 2-(isotridecyloxypolyethyleneoxy)ethyl carboxymethyl ether, Marlowet 4538®, Hills).

Examples of cationic or zwitterionic surfactants are as follows (where EO=ethylene oxide units, PO=propylene oxide units, and BO=butylene oxide units):
d2-1) alkylene oxide adducts of fatty amines, quaternary ammonium compounds having 8 to 22 carbon atoms (C₈-C₂₂), such as the Genamin® C, L, O, and T grades from Clariant, for example;
d2-2) surface-active zwitterionic compounds such as taurides, betaines and sulfobetaines in the form of Tegotain® grades from Goldschmidt, and Hostapon T and Arkopon T grades from Clariant.

Examples of nonionic surfactants are:
d3-1) fatty alcohols having 10-24 carbon atoms with 0-60 EO and/or 0-20 PO and/or 0-15 BO in any order. Examples of such compounds are Genapol® C, L, O, T, UD, UDD, and X grades from Clariant, Plurafac® and Lutensol® A, AT, ON, and TO grades from BASF, Marlipal 24 and O13 grades from Condea, Dehypon® grades from Henkel, and Ethylan® grades from Akzo-Nobel, such as Ethylan CD 120;
d3-2) fatty acid alkoxylates and triglyceride alkoxylates such as the Serdox NOG grades from Condea or the Emulsogen® grades from Clariant;
d3-3) fatty acid amide alkoxylates such as the Comperlan grades from Henkel or the Amami grades from Rhodia;
d3-4) alkylene oxide adducts of alkynediols, such as the Surfynol grades from Air Products; sugar derivatives such as amino sugars and amido sugars from Clariant,
d3-5) glucitols from Clariant,
d3-6) silicone- and/or silane-based surface-active compounds such as the Tegopren grades from

Goldschmidt and the SE® grades from Wacker, and also the Bevaloid , Rhodorsil , and Silcolapse® grades from Rhodia (Dow Corning, Reliance, GE, Bayer),
d3-7) surface-active sulfonamides, from Bayer, for example;
d3-8) surface-active polyacrylic and polymethacrylic derivatives such as the Sokalan® grades from BASF;
d3-9) surface-active polyamides such as modified gelatins or derivatized polyaspartic acid from Bayer, and derivatives thereof,
d3-10) surfactant polyvinyl compounds such as modified PVP, such as the Luviskol grades from BASF and the Agrimer® grades from ISP, or the derivatized polyvinyl acetates, such as the Mowilith® grades from Clariant, or the polyvinyl butyrates, such as the Lutonal® grades from BASF, the Vinnapas® and the Pioloform® grades from Wacker, or modified polyvinyl alcohols, such as the Mowiol® grades from Clariant,
d3-11) surface-active polymers based on maleic anhydride and/or reaction products of maleic anhydride and also maleic anhydride copolymers and/or copolymers containing reaction products ofmaleic anhydride, such as the Agrimer® VEMA grades from ISP,
d3-12) surface-active derivatives of montan waxes, polyethylene waxes, and polypropylene waxes, such as the Hoechst® waxes or the Licowet® grades from Clariant,
d3-13) polyol-based alkylene oxide adducts, such as Polyglycol grades from Clariant;
d3-14) surface-active polyglycerides and derivatives thereof from Clariant.

The weight ratio of the total amount of constituent (a) to the total amount of anionic surfactants of constituent (d) in a composition for use in accordance with the present invention preferably is in the range from 5:1 to 1:10, preferably 5:1 to 1:10, in particular 2:1 to 1:6.

The weight ratio of the total amount of constituent (a) to the total amount of nonionic surfactants of constituent (d) in a composition for use in accordance with the present invention preferably is in the range from 20:1 to 1:1, preferably 10:1 to 2:1, especially 8:1 to 3:1.

The compositions for use according to the present invention preferably comprise, as part of constituent (d), one or more nonionic surfactants from the group of the alkylpolyglycosides. Preferred alkylpolyglycosides in this context are the following:

alkylpolysaccharides and mixtures thereof such as those, for example, from the Atplus range from Uniqema, preferably Atplus 435,

alkylpolyglycosides in the form of the APG grades from Henkel, an example being Plantaren APG 225 (fatty alcohol C₈-C₁₀ glucoside),

sorbitan esters in the form of the Span or Tween grades from Uniqema,

cyclodextrin esters or ethers from Wacker,

surface-active cellulose derivatives and algin, pectin, and guar derivatives such as the Tyloses grades from Clariant, the Manutex® grades from Kelco, and guar derivatives from Cesalpina,

alkylpolyglycoside-alkylpolysaccharide mixtures based on C₈-C₁₀ fatty alcohol, such as Glucopon 225 DK and ®Glucopon 215 CSUP (Cognis).

Preferred as alkylpolyglycosides are the alkylpolyglycosides-alkylpolysaccharide mixtures such as Atplus 435.

The compositions for use according to the present invention may comprise as constituent (e) inorganic salts from the group of ammonium salts, examples being ammonium sulfate, ammonium chloride, ammonium bromide, preferably ammonium sulfate.

The use of alkylpolyglycosides as surfactants in crop protectant compositions is known in principle (see, for example U.S. Pat. No. 5,258,358). It is also mentioned therein that ammonium sulfate can be added as a frost protectant.

The compositions for use in the context of the present invention may optionally comprise as constituent (g) customary formulation adjuvants, for example stickers, wetters, dispersants, penetrants, preservatives, frost protectants, fillers, carriers, colorants, evaporation inhibitors, pH modifiers (such as buffers, acids, and bases), viscosity modifiers (e.g. thickeners) or defoamers (defoaming agents).

Preferred formulation adjuvants (g) are defoamers, frost protectants, carriers, evaporation inhibitors and preservatives, e.g., Mergal K9N® (Riedel) or Cobate C®.

In a preferred embodiment fatty acid mono-alkyl esters are used as a formulation adjuvant of constituent (g), preferably fatty acid mono-alkyl esters derived from vegetable oil, more preferably soybean oil methyl esters.

In the aqueous compositions for use in the context of the present invention it is often advantageous to add defoamers. Suitable defoamers include all customary defoamers, preferably silicone-based defoamers, such as silicone oils.

Preferred defoamers are those from the group of linear polydimethylsiloxanes having an average dynamic viscosity, measured at 25° C., in the range from 1000 to 8000 mPas (mPas=millipascal-second), preferably 1200 to 6000 mPas, and containing silica. Silica comprehends forms/modifications such as polysilicic acids, meta-silicic acid, ortho-silicic acid, silica gel, silicic acid gels, kieselguhr, precipitated SiO₂, etc.

Defoamers from the group of linear polydimethylsiloxanes contain as their chemical backbone a compound of the formula HO—[Si(CH₃)₂—O—]ₙ—H, in which the end groups are modified, by etherification for example, or, in general, are attached to the groups —Si(CH₃)₃.

Examples of defoamers of this kind are ®Rhodorsil Antifoam 416 (Rhodia) and Rhodorsil Antifoam 481 (Rhodia). ®Rhodorsil Antifoam 416 is a medium-viscosity silicone oil having a dynamic viscosity at 25° C. of about 1500 mPas and containing surfactant and silica. Because of the surfactant content the density is reduced as compared with the unadditized silicone oil, and amounts to about 0.995 g/cm³. ®Rhodorsil Antifoam 481 is a medium-viscosity silicone oil having a dynamic viscosity at 25° C. of about 4500 mPas and containing silica. The density amounts to about 1.045 g/cm³. Other defoamers from the silicone group are Rhodorsil 1824, Antimussol 4459-2 (Clariant), Defoamer V 4459 (Clariant), SE Visk and AS EM SE 39 (Wacker). The silicone oils can also be used in the form of emulsions.

The compositions used in the context of the present invention may additionally comprise (as constituent (f)) further active crop protectant ingredients, preferably herbicides from the group of diphenyl ethers, carbamates, thiocarbamates, triphenyltin and tributyltin compounds, haloacetanilides, herbicides from the group of diphenyl ethers, carbamates, thiocarbamates, triphenyltin and tributyltin compounds, haloacetanilides, phenoxyphenoxy-alkanecarboxylic acid derivatives and heteroaryloxyphenoxyalkanecarboxylic acid derivatives, such as quinolyloxy-, quinoxalyloxy-, pyridyloxy-, benzoxalyloxy- and benzothiazolyloxyphenoxyalkanecarboxylic esters, which generally have a suitable solubility in organic solvents, examples being active ingredients such as oxyfluorfen, diclofop-methyl, fenoxaprop-ethyl or fenoxaprop-P-ethyl.

It is also possible to include one or more further active ingredients from the group of safeners, plant growth regulators, insecticides, and fungicides as constituent (f).

The compositions for use in the context of the present invention can be prepared by processes which are customary and known in the art, i.e., by mixing the ingredients with stirring or shaking or by means of static mixing techniques.

Preferably, compositions used according to the present invention (preferably in one of the preferred embodiments defined herein) are used in the form of soluble (liquid) concentrates, i.e. as SL formulation.

The individual formulation types are known in principle and are described for example, in: Winnacker-Kiichler, “Chemische Technologie”, Volume 7, C. Hauser Verlag Munich, 4^{th} Edition, 1986; van Valkenburg, “Pesticide Formulations”, Marcel Dekker N.Y., 1973; K. Martens, “Spray Drying Handbook”, 3rd Ed. 1979, G. Goodwin Ltd. London.

The formulation auxiliaries required, such as inert materials, surfactants, solvents and other additives are also known and are described, for example, in Watkins, “Handbook of Insecticide Dust Diluents and Carriers”, 2nd Ed., Darland Books, Caldwell N.J.; H.v. Olphen, “Introduction to Clay Colloid Chemistry”; 2nd Ed., J. Wiley & Sons, N.Y. Marsden, “Solvents Guide”, 2nd Ed., Interscience, N.Y. 1950; McCutcheon's, “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflachenaktive Athylenoxidaddukte” [ Surface-active ethylene oxide adducts], Wiss. Verlagsgesellschaft, Stuttgart 1976, Winnacker-Kiichler, “Chemische Technologie”, Volume 7, C. Hauser Verlag Munich, 4^{th} Edition 1986.

Based on these formulations, combinations with other agrochemically active substances, such as other herbicides, fungicides or insecticides, and with safeners, fertilizers and/or growth regulators, may also be prepared, for example in the form of a readymix or a tank mix.

As regards further details on the formulation of crop protection products, see, for example, G.C. Klingmam, “Weed Control as a Science”, John Wiley and Sons, Inc., New York, 1961, pages 81-96 and J.D. Freyer, S.A. Evans, “Weed Control Handbook”, 5th Ed., Blackwell Scientific Publications, Oxford, 1968, pages 101-103.

In addition, the abovementioned active compound formulations may comprise, if appropriate, the conventional adhesives, wetters, dispersants, emulsifiers, preservatives, antifreeze agents, solvents, fillers, colorants, carriers, antifoams, evaporation inhibitors, pH regulators or viscosity regulators.

For use, the formulations, which are present in commercially available form, are optionally diluted in the customary manner, for example using water in the case of wettable powders, emulsifiable concentrates, dispersions and water-dispersible granules. Preparations in the form of dusts, soil granules, granules for broadcasting and sprayable solutions are usually not diluted further with other inert substances prior to use.

### EXAMPLES

In the following examples, amounts are by weight, unless indicated otherwise.

1. Suitable Products

The following products P1 to P6 can be used in the context of the present invention.

The composition examples shown in the following table are concentrates suitable—after appropriate dilution with water—for use in the context of the present invention. The section “Biological examples” summarizes results of biological field trials.

TABLE P
Compositions (concentrates) containing L-glufosinate ammonium (P1 to
P6) or racemic glufosinate ammonium (PX)

| All amounts in wt. % | P1 | P2 | P3 | P4 | P5 | P6 | PX |
|---|---|---|---|---|---|---|---|
| L-Glufosinate-ammonium (a.i.) | 12.73 | 24.50 | 18.02 | 9.43 | 13.51 | 6.94 | — |
| rac-Glufosinate-ammonium ⁽¹⁾ | — | — | — | — | — | — | 24.50 |
| Alkyl ether sulfate, Na salt ⁽²⁾ | 31.55 | 31.55 | 30.00 | 30.00 | 58.81 | 58.81 | 31.55 |
| C₈-C₁₀ Alkyl PolyGlycoside ⁽³⁾ | 9.76 | 9.76 | — | — | — | — | 9.76 |
| 1-Methoxy-2-propanol | 1.00 | 1.00 | 10.00 | 10.00 | 10.00 | 10.00 | 1.00 |
| Dipropylene glycol | 8.56 | 8.56 | — | — | — | — | 8.56 |
| Defoamer | 0.05 | 0.05 | 0.25 | 0.25 | 0.25 | 0.25 | 0.05 |
| Color | 0.08 | 0.08 | 0.0005 | 0.0005 | 0.0005 | 0.0005 | 0.08 |
| Water | ad 100 | ad 100 | ad 100 | ad 100 | ad 100 | ad 100 | ad 100 |

Abbreviations used:
(a.i.) active ingredient
⁽¹⁾ rac-Glufosinate-ammonium = racemic glufosinate-ammonium (a.i.)
⁽²⁾ Alkyl ether sulfate, Na salt was used as ® Genapol LRO from Clariant (C₁₂/C₁₄ fatty alcohol diethylene glycol ether sulfate, sodium salt)
⁽³⁾ C₈-C₁₀ Alkyl PolyGlycoside was used as ® Agnique PG 8105 from Cognis

2. Biological Examples

Herbicidal action (field trials)

The harmful plants and the field crop plants grew under natural outdoor conditions. After the harmful plants had emerged, they were treated with various dosages of the compositions suitable according to the invention at a water application rate of 140 L/ha (converted).

After the respective treatment, the herbidical activity was scored visually by comparing the treated plots with the untreated control plots. Damage and development of all above-ground parts of the plants was recorded. Scoring (rating) was done on a percentage scale (100% action=all plants dead; 50% action=green plant biomass reduced by 50%, and 0% action=no discernible action=like control plot).

Tables 1A, 1B, 2A, 2B and 2C reflect the respective observed herbicidal activity ratings after treatment of the harmful plant species and the field crop plants for the different products applied once in post-emergence. The Tables 1A, 1B, 2A, 2B and 2C reflect the observations after certain periods of time, indicated in days (referred to as DAA =days after application) after start of treatment with / application of the respective product P1 or PX mentioned above, each in the amounts indicated below. For example, DAA X refers to the time of X days after application of the respective product, and the Tables below reflect the herbicidal activity observed at that time.

Additionally, the maximum ratings of herbicidal activity (MAX) observed in the observation period DAA 7 to DAA 21 (or DAA 28 in case of BRSNS) in each glufosinate tolerant field crop species are mentioned in Tables 2B and 2C.

The growth stages of the different weed or crop plant species are indicated according to the BBCH monograph “Growth stages of mono-and dicotyledonous plants”, 2n^{d} edition, 2001, ed. Uwe Meier, Federal Biological Research Centre for Agriculture and Forestry (Biologische Bundesanstalt ftir Land and Forstwirtschaft). The respective BBCH stages are mentioned in brackets for the different weed or crop plant species and indicate the BBCH stage for the majority of the respective weed or crop plant species.

The dose rates of herbicidal ingedients used in each case are indicated for the respective active ingredient in brackets and refer to the amount of active ingredient per hectare (g/ha).

The results of the treatments are reflected in the Tables 1A, 1B, 2A, 2B and 2C below.

The herbicidal activity effects observed in the glufosinate tolerant field crop species mainly were chlorosis and stunting (stunted growth).

The tested glufosinate tolerant field crop varieties were (see Tables 1B, 2B and 2C):

Soybean (GLXMA) variety: CZ5515LL (Bayer)

Cotton (GOSHI) variety: ST 4747GLB2 (Bayer)

Corn (ZEAMX) variety: P1142_{AMX}™ (DuPont Pioneer)

Canola (BRSNS) variety: InVigor® L140P (Bayer)

The following products, abbreviations and plants are used and referred to in the Tables 1A, 1B, 2A, 2B and 2C:

P1: SL-formulation containing L-glufosinate-ammonium, see above Table P

PX: SL-formulation containing rac-glufosinate-ammonium, see above Table P

| Harmful plants treated | BBCH stage |
|---|---|
| AMAPA: Amaranthus palmeri | 15 (5 true leaves) |
| ABUTH: Abutilon theophrasti | 13 (3 true leaves) |
| TRTPO: Trianthema portulacastrum | 19 (9 true leaves) |

| Glufosinate tolerant field crop plants treated | BBCH stage |
|---|---|
| GLXMA: Glycine max (soybean) | 12 (2 true leaves) |
| GOSHI: Gossypium hirsutum (cotton) | 11 (1^{st} true leave) |
| ZEAMX: Zea mays (corn) | 13 (3 true leaves) |
| BRSNS: Brassica napus (spring rape) | 14 (4 true leaves) |

The products P1 and PX were used in the amounts indicated in the respective Tables below in foliar application.

In case of GLXMA, GOSHI and ZEAMX foliar applications were performed at an air temperature of 24° C. (measured 2 m above the ground) and at a relative humidity of 55% or above; the soil temperature was 25° C. (at 10 cm depth).

In case of BRSNS foliar applications were performed at an air temperature of 24° C. (measured 2 m above the ground) and at a relative humidity of 64% or above, soil temperature 21° C. (at 10 cm depth).

TABLE 1A
Ratings of herbicidal activity in field trials against the above-mentioned
harmful plant species after single post-emergence treatment with products
P1 and PX in an amount of 300 g/ha of L-glufosinate-ammonium and
300 g/ha of racemic glufosinate-ammonium, respectively

| | Product | | | | | |
|---|---|---|---|---|---|---|
| Weed | P1: 300 g/ha of | | | PX: 300 g/ha of racemic | | |
| (BBCH stage | L-glufosinate-ammonium | | | glufosinate-ammonium | | |
| at treatment) | DAA 7 | DAA 14 | DAA 21 | DAA 7 | DAA 14 | DAA 21 |
| AMAPA (15) | 100% | 100% | 100% | 63% | 70% | 75% |
| ABUTH (13) | 100% | 100% | 100% | 78% | 82% | 83% |
| TRTPO (19) | 90% | 92% | 93% | 60% | 63% | 60% |

TABLE 1B
Ratings of herbicidal activity in field trials against the above-mentioned
glufosinate tolerant field crop species after a single post-emergence
treatment with products P1 and PX in an amount of 300 g/ha of L-
glufosinate-ammonium and 300 g/ha of racemic glufosinate-ammonium,
respectively

| | Product | | | | | |
|---|---|---|---|---|---|---|
| Field crop | P1: 300 g/ha of | | | PX: 300 g/ha of racemic | | |
| (BBCH stage | L-glufosinate-ammonium | | | glufosinate-ammonium | | |
| at treatment) | DAA 7 | DAA 14 | DAA 21 | DAA 7 | DAA 14 | DAA 21 |
| GLXMA (12) | 0% | 0% | 0% | 0% | 0% | 0% |
| ZEAMX (13) | 5% | 5% | 5% | 5% | 5% | 5% |

TABLE 2A
Ratings of herbicidal activity in field trials against the above-mentioned
harmful plant species after a single post-emergence treatment with
products P1 and PX in an amount of 600 g/ha of L-glufosinate-
ammonium and 600 g/ha of racemic glufosinate-ammonium, respectively

| | Product | | | | | |
|---|---|---|---|---|---|---|
| | P1: 600 g/ha of | | | PX: 600 g/ha of racemic | | |
| Weed | L-glufosinate-ammonium | | | glufosinate-ammonium | | |
| (BBCH stage) | DAA 7 | DAA 14 | DAA 21 | DAA 7 | DAA 14 | DAA 21 |
| AMAPA (15) | 100% | 100% | 100% | 95% | 95% | 97% |
| ABUTH (13) | 100% | 100% | 100% | 100% | 100% | 100% |
| TRTPO (19) | 95% | 95% | 95% | 82% | 85% | 87% |

TABLE 2B
Ratings of herbicidal activity in field trials against the above-mentioned glufosinate
tolerant field crop species GLXMA, GOSHI and ZEAMX after a single
post-emergence treatment with products P1 and PX in an amount of 600 g/ha of
L-glufosinate-ammonium and 600 g/ha of racemic glufosinate-ammonium,
respectively

| | Product | | | | | | | |
|---|---|---|---|---|---|---|---|---|
| | P1: 600 g/ha of | | | | PX: 600 g/ha of racemic | | | |
| Field crop | L-glufosinate-ammonium | | | | glufosinate-ammonium | | | |
| (BBCH stage) | DAA 7 | DAA 15 | DAA 28 | MAX | DAA 7 | DAA 15 | DAA 28 | MAX |
| GLXMA (12) | 3% | 0% | 0% | 3% | 8% | 5% | 5% | 8% |
| GOSHI (11) | 0% | 0% | 0% | 0% | 10% | 7% | 5% | 10% |
| ZEAMX (13) | 8% | 5% | 5% | 8% | 13% | 8% | 6% | 13% |

TABLE 2C
Ratings of herbicidal activity in field trials against the above-mentioned glufosinate
tolerant field crop species BRSNS after a single post-emergence treatment with
products P1 and PX in an amount of 1800 g/ha of L-glufosinate-ammonium and
1200 g/ha of racemic glufosinate-ammonium, respectively

| | Product | | | | | | | |
|---|---|---|---|---|---|---|---|---|
| | P1: 1800 g/ha of | | | | PX: 1200 g/ha of racemic | | | |
| Field crop | L-glufosinate-ammonium | | | | glufosinate-ammonium | | | |
| (BBCH stage) | DAA 7 | DAA 15 | DAA 28 | MAX | DAA 7 | DAA 15 | DAA 28 | MAX |
| BRSNS (14) | 15% | 4% | 7% | 15% | 18% | 9% | 7% | 18% |

1. Use of a composition comprising a herbicidally effective amount of L-glufosinate and/or agronomically acceptable salts thereof in a glufosinate tolerant field crop, wherein the composition contains less than 5 mol.-% of D-glufosinate and/or agronomically acceptable salts thereof, based on the total amount of L-glufosinate and salts thereof, to achieve:
(i) an increase in the control of harmful plants, in comparison to twice the molar amount of racemic glufosinate and/or agronomically acceptable salts thereof, and/or
(ii) a reduction of phytotoxicity, in particular of chlorosis and/or stunting, caused to the glufosinate tolerant field crop, in comparison to the same molar amount of racemic glufosinate and/or agronomically acceptable salts thereof, wherein the composition is used in foliar application at an air temperature of 18° C. or above; when measured 2 m above the ground.

2. The use according to claim 1, wherein the composition is used in foliar application at a relative humidity of 50% or above.

3. The use according to claim 1 [[or 2]], wherein the composition further comprises water, one or more organic solvents and one or more surfactants.

4. The use according to claim 1, wherein the field crop is selected from the group consisting of soybean, cotton, oilseed rape, maize (corn) and sweet corn.

5. The use according to claim 1, wherein L-glufosinate and/or agronomically acceptable salts thereof are selected from the group consisting of L-glufosinate, L-glufosinate-ammonium, L-glufosinate-potassium, and L-glufosinate-sodium, preferably L-glufosinate-ammonium or L-glufosinate-sodium.

6. The use according to claim 1, wherein the only herbicide in the composition is glufosinate and/or agronomically acceptable salts thereof.

7. The use according to claim 1, wherein L-glufosinate and/or agronomically acceptable salts thereof is used in a total amount per year in the range of from 100 to 1200 g/ha.

8. The use according to claim 1, wherein:
(i) the herbicidal activity is increased by 3% or more, in comparison to a composition comprising twice the molar amount of racemic glufosinate and/or salts thereof, and/or
(ii) the crop damage is reduced by 10% or more, preferably by 20% or more, in comparison to a composition comprising the same molar amount of racemic glufosinate and/or salts thereof,
in each case when assessed 5 to 14 days after application of the composition.

9. The use according to claim 1, wherein:
(i) the herbicidal activity is increased by 3% or more, and/or
(ii) the crop damage is reduced by 10% or more, preferably by 20% or more, in each case when assessed 5 to 14 days after application of the composition and in comparison to a composition comprising twice the molar amount of racemic glufosinate and/or salts thereof.

10. A method for controlling harmful plants in a glufosinate tolerant field crop, comprising the following steps:
(a) providing a composition comprising L-glufosinate and/or salts thereof, wherein the composition contains less than 5 mol.-% of D-glufosinate and/or agronomically acceptable salts thereof, based on the total amount of L-glufosinate and salts thereof, and optionally diluting said composition with water,
(b) applying a herbicidally effective amount of the composition of step (a) to leaves of harmful plants and a glufosinate tolerant field crop,
wherein the application step (b) is at an air temperature of 18° C. or above when measured 2 m above the ground.

11. The method according to claim 10, wherein L-glufosinate and/or salts thereof are selected from the group consisting of L-glufosinate, L-glufosinate-ammonium, L-glufosinate-potassium, and L-glufosinate-sodium, preferably L-glufosinate-ammonium or L-glufosinate-sodium.

12. The method according to claim 10, wherein the field crop is selected from the group consisting of soybean, cotton, oilseed rape and maize (corn).

13. The method according to claim 10, wherein:
an increase in the control of harmful plants, in comparison to twice the molar amount of racemic glufosinate and/or agronomically acceptable salts thereof, and/or
(ii) a reduction of phytotoxicity, in particular of chlorosis and/or stunting, caused to the glufosinate tolerant field crop, in comparison to the same molar amount of racemic glufosinate and/or agronomically acceptable salts thereof,
is achieved.

14. The method according to claim 10, wherein
(i) an increase in the control of harmful plants of 3% or more, in comparison to twice the molar amount of racemic glufosinate and/or agronomically acceptable salts thereof, and/or
(ii) a reduction of phytotoxicity of 10% or more, in particular of chlorosis and/or stunting, caused to the glufosinate tolerant field crop, in comparison to twice the molar amount of racemic glufosinate and/or agronomically acceptable salts thereof,
is achieved.

15. The method according to claim 10, wherein L-glufosinate and/or salts thereof is applied in a total amount per year in the range of from 100 to 1200 g/ha.

16. The method according to claim 10, wherein the application step (b) is at an air temperature of 21° C. or above when measured 2 m above the ground.

17. The method according to claim 10, wherein the application step (b) is at an air temperature of 24° C. or above when measured 2 m above the ground.

18. The method according to claim 10, wherein L-glufosinate and/or salts thereof is applied in a total amount per year in the range of from 150 to 600 g/ha.

19. The method according to claim 10, wherein L-glufosinate and/or salts thereof is applied in a total amount per year in the range of from 200 to 500 g/ha.

20. The method according to claim 10, wherein L-glufosinate and/or salts thereof is applied in a total amount per year in the range of from 250 to 450 g/ha.


SEQUENCE LISTING (7 sequences)

SEQ ID NO: 1 - protein, 183 aa, Artificial Sequence
  amino acid sequence of the BAR protein from Streptomyces hygroscopicus
MSPERRPADIRRATEADMPAVCTIVNHYIETSTVNFRTEPQEPQEWTDDLVRLRERYPWLVAEVDGEVAGIAYAGPWKARNAYDWTAESTVYVSPRHQRTGLGSTLYTHLLKSLEAQGFKSVVAVIGLPNDPSVRMHEALGYAPRGMLRAAGFKHGNWHDVGFWQLDFSLPVPPRPVLPVTEI

SEQ ID NO: 2 - protein, 183 aa, Artificial Sequence
  amino acid sequence of the BAR protein variant described in WO87/05629
MDPERRPADIRRATEADMPAVCTIVNHYIETSTVNFRTEPQEPQEWTDDLVRLRERYPWLVAEVDGEVAGIAYAGPWKARNAYDWTAESTVYVSPRHQRTGLGSTLYTHLLKSLEAQGFKSVVAVIGLPNDPSVRMHEALGYAPRGMLRAAGFKHGNWHDVGFWQLDFSLPVPPRPVLPVTEI

SEQ ID NO: 3 - protein, 183 aa, Artificial Sequence
  amino acid sequence of the PAT protein from Streptomyces viridichromogenes
MSPERRPVEIRPATAADMAAVCDMVNHYIETSTVNFRTEPQTPQEWIDDLERLQDRYPWLVAEVEGVVAGIAYAGPWKARNAYDWTVESTVYVSHRHQRLGLGSTLYTHLLKSMEAQGFKSVVAVIGLPNDPSVRLHEALGYTARGTLRAAGYKHGGWHDVGFWQRDFELPAPPRPVRPVTQI

SEQ ID NO: 4 - DNA, 549 bp, Artificial Sequence
  nucleotide sequence of the bar coding region from S. hygroscopicus (with ATG start codon)
atgagcccagaacgacgcccggccgacatccgccgtgccaccgaggcggacatgccggcggtctgcaccatcgtcaaccactacatcgagacaagcacggtcaacttccgtaccgagccgcaggaaccgcaggagtggacggacgacctcgtccgtctgcgggagcgctatccctggctcgtcgccgaggtggacggcgaggtcgccggcatcgcctacgcgggcccctggaaggcacgcaacgcctacgactggacggccgagtcgaccgtgtacgtctccccccgccaccagcggacgggactgggctccacgctctacacccacctgctgaagtccctggaggcacagggcttcaagagcgtggtcgctgtcatcgggctgcccaacgacccgagcgtgcgcatgcacgaggcgctcggatatgccccccgcggcatgctgcgggcggccggcttcaagcacgggaactggcatgacgtgggtttctggcagctggacttcagcctgccggtaccgccccgtccggtcctgcccgtcaccgagatc

SEQ ID NO: 5 - DNA, 549 bp, Artificial Sequence
  nucleotide sequence of the bar coding region variant described in WO87/05629
atggacccagaacgacgcccggccgacatccgccgtgccaccgaggcggacatgccggcggtctgcaccatcgtcaaccactacatcgagacaagcacggtcaacttccgtaccgagccgcaggaaccgcaggagtggacggacgacctcgtccgtctgcgggagcgctatccctggctcgtcgccgaggtggacggcgaggtcgccggcatcgcctacgcgggcccctggaaggcacgcaacgcctacgactggacggccgagtcgaccgtgtacgtctccccccgccaccagcggacgggactgggctccacgctctacacccacctgctgaagtccctggaggcacagggcttcaagagcgtggtcgctgtcatcgggctgcccaacgacccgagcgtgcgcatgcacgaggcgctcggatatgccccccgcggcatgctgcgggcggccggcttcaagcacgggaactggcatgacgtgggtttctggcagctggacttcagcctgccggtaccgccccgtccggtcctgcccgtcaccgagatc

SEQ ID NO: 6 - DNA, 552 bp, Artificial Sequence
  nucleotide sequence of the pat coding region from S. virdochromogenes(with ATG start codon)
atgagcccagaacgacgcccggtcgagatccgtcccgccaccgccgccgacatggcggcggtctgcgacatcgtcaatcactacatcgagacgagcacggtcaacttccgtacggagccgcagactccgcaggagtggatcgacgacctggagcgcctccaggaccgctacccctggctcgtcgccgaggtggagggcgtcgtcgccggcatcgcctacgccggcccctggaaggcccgcaacgcctacgactggaccgtcgagtcgacggtgtacgtctcccaccggcaccagcggctcggactgggctccaccctctacacccacctgctgaagtccatggaggcccagggcttcaagagcgtggtcgccgtcatcggactgcccaacgacccgagcgtgcgcctgcacgaggcgctcggatacaccgcgcgcgggacgctgcgggcagccggctacaagcacgggggctggcacgacgtggggttctggcagcgcgacttcgagctgccggccccgccccgccccgtccggcccgtcacacagatctga

SEQ ID NO: 7 - DNA, 552 bp, Artificial Sequence
  nucleotide sequence of the synthetic pat coding region described in US 5,276,268
atgtctccggagaggagaccagttgagattaggccagctacagcagctgatatggccgcggtttgtgatatggttaaccattacattgagacgtctacagtgaactttaggacagagccacaaacaccacaagagtggattgatgatctagagaggttgcaagatagatacccttggttggttgctgaggttgagggtgttgtggctggtattgcttacgctgggccctggaaggctaggaacgcttacgattggacagttgagagtactgtttacgtgtcacataggcatcaaaggttgggcctaggatccacattgtacacacatttgcttaagtctatggaggcgcaaggttttaagtctgtggttgctgttataggccttccaaacgatccatctgttaggttgcatgaggctttgggatacacagcccggggtacattgcgcgcagctggatacaagcatggtggatggcatgatgttggtttttggcaaagggattttgagttgccagctcctccaaggccagttaggccagttacccagatctga